(19) United States
(12) Patent Application Publication
(10) Pub. No.: US 2016/0092636 A1
(43) Pub. Date: Mar. 31, 2016

(54) Automated and Timely Alert Method of Notifying an adverse reaction at Point of Service

(71) Applicant: Surabhi K. Venkataramu, Alpharetta, GA (US)

(72) Inventor: Surabhi K. Venkataramu, Alpharetta, GA (US)

(21) Appl. No.: 14/847,691

(22) Filed: Sep. 8, 2015

Related U.S. Application Data
(60) Provisional application No. 62/056,196, filed on Sep. 26, 2014.

(51) Int. Cl. G06F 19/00

(52) U.S. Cl. CPC G06F 19/323; G06F 19/3475

(57) ABSTRACT

An automated and timely method of notifying the possibility of an adverse reaction at the point of service is implemented through a computing device and at least one data-transceiver as the computing device is communicatively coupled with the data-transceiver through a wireless network. The computing device is able to receive a user information and the possibility of an adverse reaction information from a desired transceiver of the at least one data-transceiver, where the adverse reaction information notifies any possible adverse reactions at the point of service. As a result, the service provider or seeker who operates the computing device is able to assess an appropriate service procedure for the desired transceiver in such a way that the appropriate service procedure avoids further medical complication for the person with the desired transceiver at the point of service.

The current application claims a priority to the U.S. Provisional Patent application Ser. No. 62/056,196 filed on Sep. 26, 2014.

### FIELD OF THE INVENTION

The present invention relates generally to an allergy alert system. More specifically, the present invention is an automated timely alert system that is dedicated towards notifying the responsible party of any allergies, drug-sensitivities, food sensitivities, food preferences, pre-existing medical conditions, and other inclinations at point of service locations.

### BACKGROUND OF THE INVENTION

Every day in normal life, many types of “Seeker—Provider” interactions take place, and the provider serves the needs of the seeker. When the seeker is faced with possible adverse reactions from conditions such as food allergies, drug allergies, environmental allergies, and insect allergies, the sensitivity for those occurrences becomes a major factor for the provider as medical complications can produce adverse reactions or in extreme cases, anaphylactic shock and even death. Without knowing the sensitivity of the seeker beforehand, the provided service performed in good faith by the provider can be harmful to the seeker and in some cases even to the provider.

The above mentioned information is further explained through the following examples. Many school children are normally served lunch at the school cafeteria. These lunches are prepared outside the cafeteria area in most cases and are brought in to be served. For most children, this system works fine. However, for children with specific food-allergies this system can be problematic as some food, if consumed without proper supervision, could cause adverse reactions. In this case, if the cafeteria's food server (also known as the provider) gets a timely allergy-alert from a child who has a specific food-allergy, just before the food is served, the child can avoid the harmful food and any further repercussions due to the consumption of the food item. A similar situation can occur when a restaurant customer is served food by a waiter at the restaurant. Another scenario is when a patient is seeking emergency medical assistance, wherein the medical professionals or other emergency care-givers are best served, if the pre-existing drug sensitivities, drug allergies, or any pre-existing medical conditions of the patient are known right at the time when the treatment is administered. This becomes paramount, when the patient is brought unconscious, suffers from speech disability or any other situation where the patient is not able to communicate effectively with the emergency medical professionals or other emergency care-givers.

It is an object of the present invention to provide timely and automated alerts pertaining to possible adverse reactions to pre-existing medical conditions, right before the intended service is provided. More specifically, the present invention is an automated and timely alert method of notifying the possible adverse reaction of the appropriate persons at point of service location. The present invention is intended to attend to the needs of anyone with predisposition to adverse reactions due to pre-existing medical conditions and avoid further complications. Thus the present invention is extremely helpful for food-servers, medical-professionals and care givers, or any other responsible party so that the provider can be made aware of the seeker's pre-disposition to adverse reaction due to pre-existing medical conditions just before the service is provided. In another scenario, through the present invention, the provider can also notify the service seeker an advance alert warning pertaining to the seeker's sensitivities and preferences. This is exemplified by a customer who is picking up food items in a grocery store. The store can broadcast through the present invention a warning alert of possible allergic ingredients on a store rack that the customers is standing near to. This is done using the customer's smart phone installed with the application of the present invention. Similar service can be provided through the present invention when a customer is picking items from a buffet food service or a self-help food service.

### BRIEF DESCRIPTION OF THE DRAWINGS

FIG. 1 is a basic flowchart illustrating the overall method of the present invention.

FIG. 2 is a basic flowchart illustrating details of the user information within the overall method of the present invention.

FIG. 3 is a basic flowchart illustrating details of the adverse reaction information within the overall method of the present invention.

FIG. 4 is a basic flowchart illustrating the automated data transfer process within the overall method of the present invention in relation to the first and second data receiving process.

FIG. 5 is a basic flowchart illustrating the automated data transfer process within the overall method of the present invention in relation to the third data receiving process.

FIG. 6 is a basic flowchart illustrating the plurality of transceiver within the overall method of the present invention.

### DETAIL DESCRIPTIONS OF THE INVENTION

All illustrations and drawings are for the purpose of describing selected versions of the present invention and are not intended to limit the scope or applicability of the present invention.

The present invention is an automated and just-in-time method of notifying pre-existing conditions and sensitivities of a person to food, drug, environment etc. at the point of service thus preventing a possible adverse reaction at point of service, wherein the present invention is executed through a computing device and at least one data-transceiver. The present invention is implemented between a service provider and a service seeker so that the service provider is safely and efficiently able to assist the service seeker just in time. The computing device, which is associated with the service provider or seeker, is communicatively coupled with a wireless network that sets an operational boundary for the present invention. The computing device includes, but is not limited to, a portable personal computer, a stationary personal computer, a smart phone, and a tablet computer. The at least one data-transceiver, which is associated with the service seeker or provider, communicatively connects with the computing device so that the present invention can be executed through a wireless network. The at least one data-transceiver is preferably an electronic tag or a smart phone within the present invention; however, the at least one data-transceiver can also be any other electronic device that wirelessly communicates with the computing device.

When the electronic tag is utilized as the at least one data-transceiver, the electronic tag functions as an active radio-frequency identification (RFID) tag and comprises a battery, a wireless micro-controller, and an internal memory. A lithium coin-cell, which is not rechargeable, is preferably used as the battery within the electronic tag to generate necessary electricity power. Alternate power sources, such as both rechargeable and primary alternative batteries and solar cells, can also be utilized within the electronic tag to generate electricity power. The wireless micro-controller along with its embedded program that is electronically connected with the battery and the internal memory performs all required tag-functionality. Additionally, the wireless micro-controller transmits embedded data to the computing device via radio frequency transmissions as the embedded data is stored within the internal memory. The electronic tag is a light-weight device and can be made in different shapes and sizes suitable for any given situation. For example, the electronic tag can be shaped into a credit card sized device that can be easily carried in a wallet, or can be part of a student/child's accessory, worn externally as a necklace or wrist band, waist belt etc. The electronic tag can also optionally comprise a data storage module so that the service seeker is able to store additional information when necessary.

When the smart phone is utilized as the at least one data-transceiver, the service seeker is required to download an electronic application or ‘App’. The electronic application allows the service seeker to utilize and navigate the present invention so that the service seeker is able to operate the smart phone according to the parameters of the present invention. More specifically, the process of the present invention is carried out by a combination of built-in features and the electronic application within the smart phone in such a way that the smart phone functions similar to the electronic tag. The key advantage of utilizing the smart phone as the at least one data-transceiver is that the smart phone is widely available and it does not mandate a separate electronic entity in its place to connect with the wireless network. However, the smart phone can also be replaced with a computer and an appropriate modem, which interacts with the computing device. Performing the primary process of the present invention, the electronic application can also, if desired, provide further action through the wireless network. For example, the electronic application can post and update the pre-existing medical condition information, activate a loud alarm when necessary, and send text or display banner alerts etc.

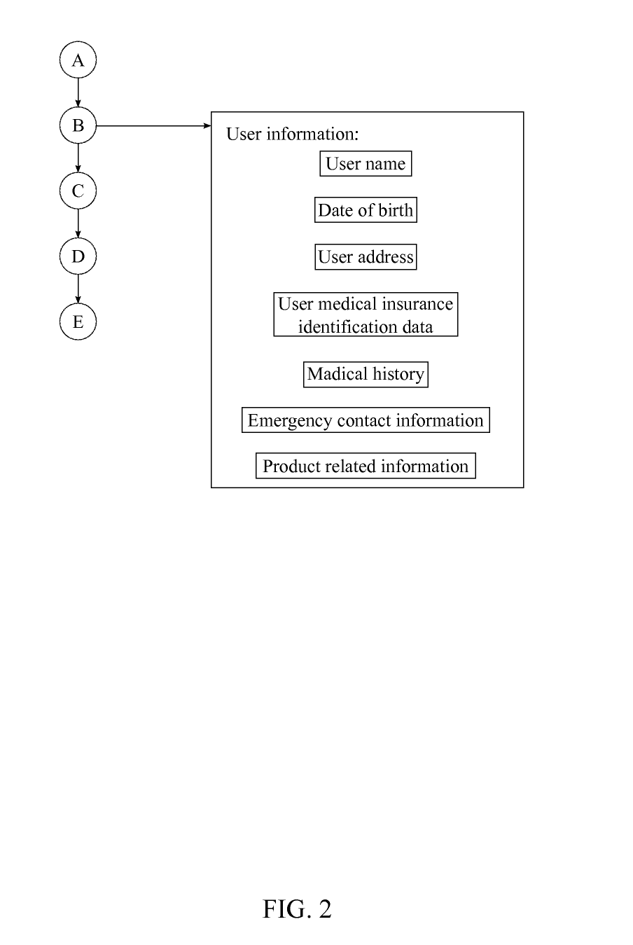

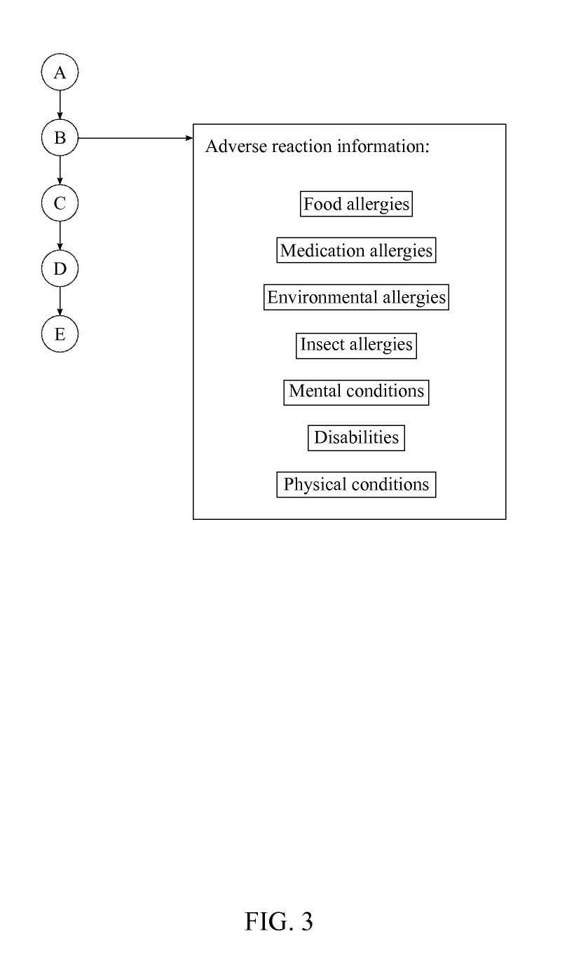

Additionally, the at least one data-transceiver is embedded with an electronic identification number, user information, pre-existing medical conditions, and an adverse reaction information in such a way that each data-transceiver is different from any other. In reference to FIG. 2 and FIG. 3, the user information uniquely identifies the service seeker of the present invention and provides valuable information to the service provider as the user information stored may include, but is not limited to, a user name, date of birth, a user address, a user medical insurance identification data, a medical history, product related information, and emergency contact information. The pre-existing medical conditions and the adverse reaction information that is critical to the health of the service seeker can be several different conditions such as food allergies, medication allergies, environmental allergies, insect allergies, mental conditions, disabilities, physical conditions, etc. The electronic identification number uniquely identifies the at least one data-transceiver and the associated user information, the pre-existing medical conditions, and the adverse reaction information. More specifically, the present invention efficiently and quickly processes the user information, the pre-existing medical conditions, and the adverse reaction information through the recognition of the electronic identification number.

In reference to different computing devices and different at least one data-transceivers, the wireless network of the present invention can also differ so that the utilized devices can be communicatively coupled with each other. More specifically, the wireless network can include, but is not limited to, a radio frequency network, a local area wireless computer network, a mesh network, a plurality of mobile telecommunication networks, and a wireless personal area network.

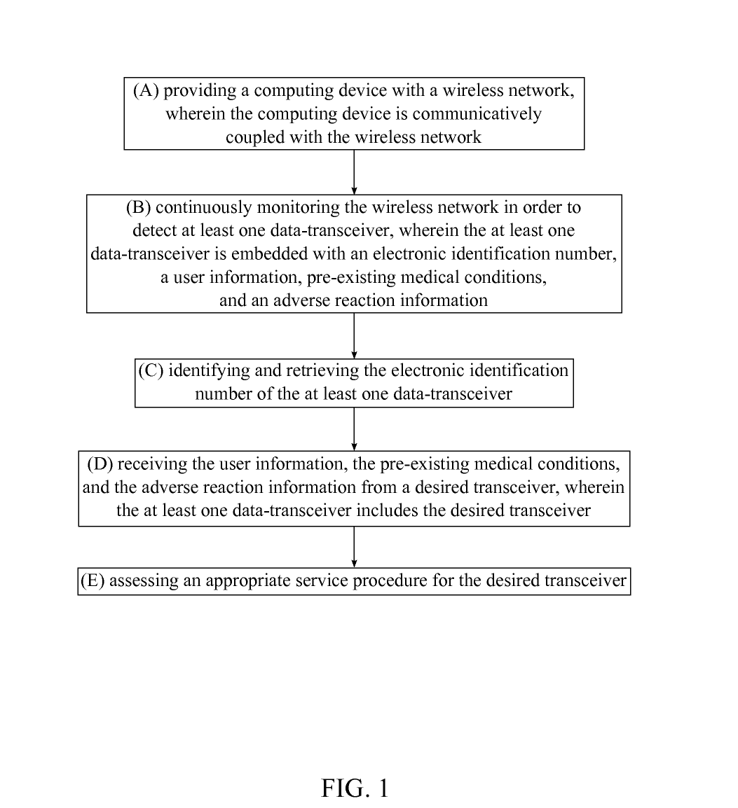

In reference to FIG. 1, when the present invention is initiated between the service seeker and the service provider, the present invention can automatically and in a timely fashion notify any kind of possible adverse reaction based on the service seeker's pre-existing medical conditions to the service provider at the point of service. Since the computing device is communicatively coupled with the wireless network, the wireless network and its protocol determine the range for the present invention to take place. The computing device continuously monitors the wireless network in order to detect the at least one data-transceiver. The wireless network can include any number of data-transceivers at a given time, where the at least one data-transceiver can be a single transceiver or a plurality of transceivers. When the electronic identification number of the at least one data-transceiver is identified by the computing device, the electronic identification number is retrieved by the computing device in order to further process through the present invention.

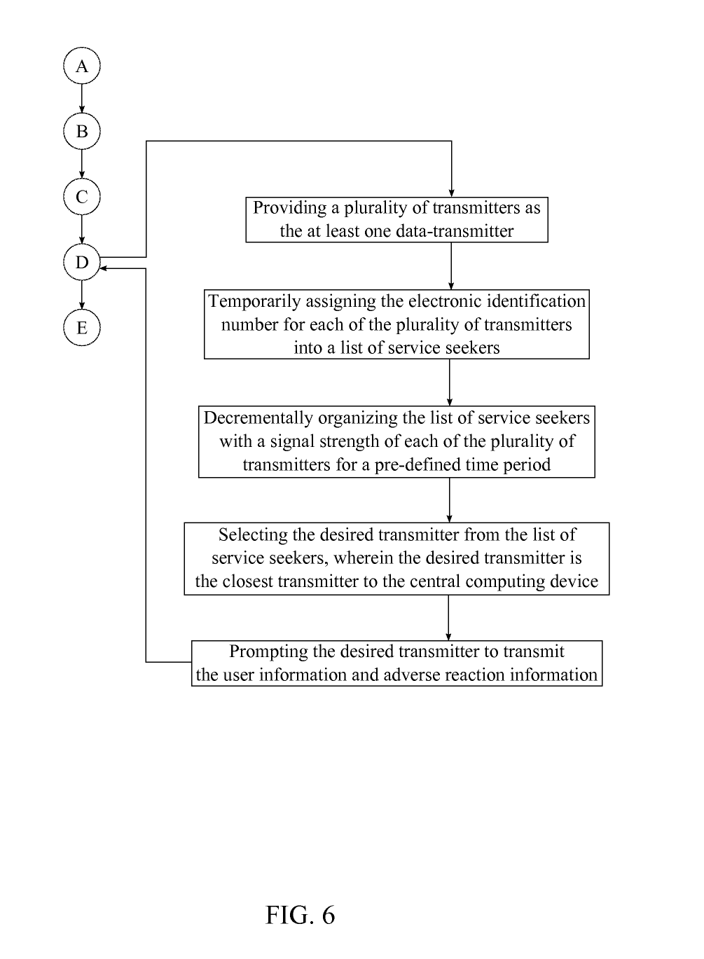

In the event of a single transceiver wherein no other transceivers are recognized within the wireless network, the single transceiver becomes a desired transceiver within the present invention at the point of service. In the event of where the at least one data-transceiver is a plurality of transceivers, the computing device identifies multiple transceivers within the wireless network; However, communicates only with the desired transceiver at the point of service. In reference to FIG. 6, the computing device temporarily assigns the electronic identification number for each of the plurality of transceivers into a list of service seekers. Then the list of service seekers is organized in a descending order according to the received signal strength of each of the plurality of transceivers for a pre-defined time period, where the pre-defined time period is preferably about one second. In other words, the list of service seekers is constantly updated at the end of the pre-defined time period so that the desired transceiver can be accurately identified through the present invention in relation to the pre-defined time period. Then the desired transceiver is selected from the list of service seekers as the desired transceiver is the closest transceiver to the computing device with the strongest signal strength. Once the desired transceiver is selected, the computing device prompts the desired transceiver to transmit the user information, the pre-existing medical conditions, and the adverse reaction information.

Then the computing device receives the user information, the pre-existing medical conditions, and the adverse reaction information from the desired transceiver. The data receiving process, transferring of the user information, the pre-existing medical conditions, and the adverse reaction information from the desired transceiver to the computing device, can be completed with three different methods, where one does not precede the other.

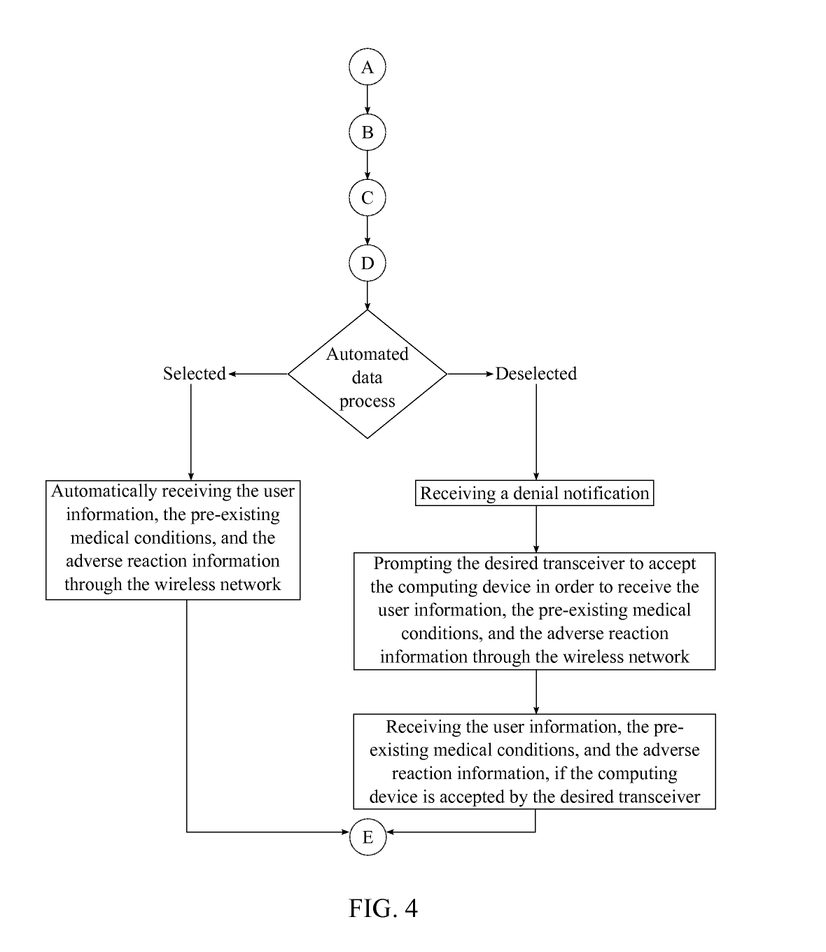

In reference to FIG. 4, the first data receiving process is recognized as the default method within the present invention, where the service seeker does not enforce any limitations to the data receiving process. More specifically, an automated data transfer process of the at least one data-transceiver is selected by the service seeker so that the computing device is able to automatically receive the user information, the pre-existing medical conditions, and the adverse reaction information from the desired transceiver, through the wireless network.

In reference to FIG. 4, the second data receiving process is recognized as the custom method within the present invention, where the service seeker controls the data receiving process of the computing device. More specifically, when the computing device initiates the data receiving process, the computing device receives a denial notification from the desired transceiver since the automated data transfer process is deselected by the service seeker. The second data receiving process provides privacy to the service seekers who wants to control distribution of the user information, the pre-existing medical conditions, and the adverse reaction information. Once the denial notification is received, the computing device prompts the desired transceiver to accept the computing device so that the user information, the pre-existing medical conditions, and the adverse reaction information can be received. Then the service seeker has the option to accept or reject the request of the computing device. For example, if the service seeker accepts the request of the computing device, the data receiving process can be implemented between the computing device and the desired transceiver. However, if the service seeker rejects the computing device, the data receiving process cannot be implemented between the computing device and the desired transceiver.

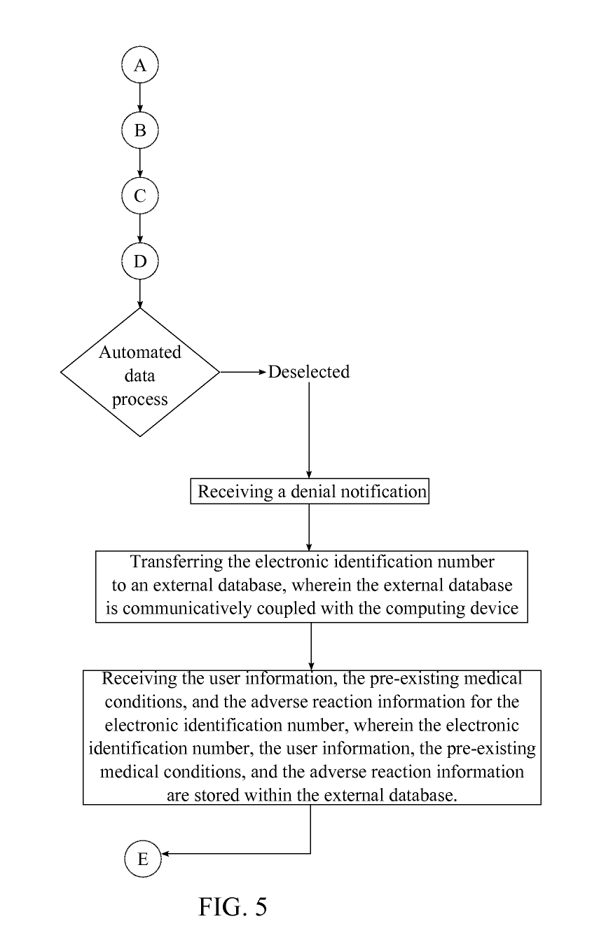

In reference to FIG. 5, the third data receiving process is also recognized as the custom method within the present invention; however, the service provider is able to execute the data receiving process even when the automated data transfer process is deselected by the service seeker. The third data receiving process can only be implemented in emergency situations by a selective group of service providers, such as doctor and emergency medical personals. More specifically, when the computing device initiates the data receiving process, the computing device receives the denial notification from the desired transceiver since the automated data transfer process is deselected by the service seeker. Then the computing device transfers the electronic identification number to an external database, where the external database is communicatively coupled with the computing device and recognizes the computing device as one of the service provider from the selective group of service providers. The computing device then receives the user information, the pre-existing medical conditions, and the adverse reaction information that are related to the electronic identification number of the desired transceiver from the external database. The external database is able to assist with the present invention in emergency situations, particularly when the service seeker is nonresponsive to the service providers, as the electronic identification number of the at least one data-transceiver, the respective user information, the respective pre-existing medical conditions, and the respective adverse reaction information are stored within the external database in addition to the at least one data-transceiver.

Once the data receiving process is completed within the present invention, the computing device is able to assess an appropriate service procedure for the desired transceiver. More specifically, the service provider determines the appropriate service procedure that directly correlates with the pre-existing medical conditions and the adverse reaction information for the service seeker. Depending on different situations, the appropriate service procedure can differ or has to be customized so that the present invention can accommodate variety of service seekers. For example, when a service seeker is trying to buy a lunch pack that contains peanuts, the computing device with the service provider receives ingredient peanut as adverse reaction information at the point of service from the service seeker's data-transceiver. Then the service provider concludes the appropriate service procedure based upon the adverse reaction information as the appropriate service procedure and informs the service seeker that his/her lunch contains peanut and should not be consumed. Once the desired transceiver completes the appropriate service procedure, the computing device temporally omits the electronic identification number from the present invention. However, if multiple transceivers are present within the wireless network, a subsequent transceiver on the list of service seekers becomes the desired transceiver to be accommodated with the appropriate service procedure.

Apart from the user information, the pre-existing medical conditions, and the possible adverse reaction information, the service seeker can optionally share additional information with the service provider at his/her discretion. The additional information can also be embedded within the at least one data-transceiver and can include, but is not limited to, Personal Health Information (PHI), any sensitive medical history, and any hospital information etc.

Following example explains how the present invention overcomes existing problems related to food allergies. Detecting allergic food is currently conducted as manual process between the service seeker and the service provider. The food consumer, who is the service seeker, has to take precautions by informing the food server, who is the service provider, upfront about his/her allergies that recognized as the adverse reaction information within the present invention. In cases such as children or adults with speech disabilities, the food consumers are not in a position to easily inform the food server about their allergic conditions. This not only increases the risk of the food consumers consuming food with ingredients that they are sensitive/allergic to but also increases the food server's liability due to his/her ignorance of such allergic conditions with respect to the sensitive/allergic ingredients. There are alarming statistics on food industry, adults and children alike, being rushed to the hospital by emergency medical personal to provide relief from adverse allergic reactions and anaphylactic shock with several cases proving fatal. As a result, such manual process fails to meet the needs of the food industry. However, when the present invention is utilized with the above mentioned food consumer and the food server, many of the adverse allergic reactions can be avoided due to the efficient and automated communication between the food consumer and the food server at the point of service. More specifically, the present invention automatically notifies the food server, which can be cafeteria staff, a restaurant waiter, and a restaurant manager, about the food allergies or other sensitivities before the food could be consumed. This data receiving process can be completed through the present invention since the allergies or other sensitivities are embedded into the at least one data-transceiver as the pre-existing medical conditions. As a result, the food server is able to assess the appropriate service procedure and administer it to the service seeker. Similarly, in case of emergency medical attention, the service seeker is able to automatically communicate his/her pre-existing medical conditions and any drug sensitivities, with the Emergency Medical Services (EMS) care giver. The data receiving process alerts the EMS professionals at the point of service about the patient's past illnesses, pre-existing medical conditions, and any drug sensitivities just in time so that the medical professionals can assess the appropriate service procedure to administer to save the patient.

Even though the preferred method of the present invention relates the service provider to the computer device and the service seeker to the at least one data transceiver, the present invention can also efficiently function when the service provider is related to the at least one data transceiver and the service seeker is related to the computing device. For example, when the at least one data transceiver is associated with a food shelf or a buffet container and the service seeker is equipped with the computing device, the at least one transceiver transmits the product related information as the user information so that the service seeker is able to avoid the food item that he/she is allergic to.

The process associated with the aforementioned invention is unique and different from any known processes or solutions available in the marketplace. The structure or physical footprint of this solution is novel and as small as possible.

Although the invention has been explained in relation to its preferred embodiment, it is to be understood that many other possible modifications and variations can be made without departing from the spirit and scope of the invention as hereinafter claimed.

What is claimed is:

1. An automated and timely method of notifying the possibility of an adverse reaction at point of service comprises the steps of:
(A) providing a computing device with a wireless network, wherein the computing device is communicatively coupled with the wireless network;
(B) continuously monitoring the wireless network in order to detect at least one data-transceiver, wherein the at least one data-transceiver is embedded with an electronic identification number, a user information, pre-existing medical conditions, and an adverse reaction information;
(C) identifying and retrieving the electronic identification number of the at least one data-transceiver;
(D) receiving the user information, the pre-existing medical conditions, and the adverse reaction information from a desired transceiver, wherein the at least one data-transceiver includes the desired transceiver; and
(E) assessing an appropriate service procedure for the desired transceiver.

2. The automated and timely method of notifying the possibility of an adverse reaction at point of service as claimed in claim 1 comprises, wherein the user information includes a user name, date of birth, a user address, a user medical insurance identification data, a medical history, and an emergency contact information.

3. The automated and timely method of notifying the possibility of an adverse reaction at point of service as claimed in claim 1 comprises, wherein the user information includes product related information.

4. The automated and timely method of notifying the possibility of an adverse reaction at point of service as claimed in claim 1 comprises, wherein the adverse reaction information includes food allergies, medication allergies, environmental allergies, insect allergies, mental conditions, disabilities, and physical conditions.

5. The automated and timely method of notifying the possibility of an adverse reaction at point of service as claimed in claim 1 comprises the steps of:
automatically receiving the user information, the pre-existing medical conditions, and the adverse reaction information through the wireless network,
if an automated data transfer process is selected by the desired transceiver.

6. The automated and timely method of notifying the possibility of an adverse reaction at point of service as claimed in claim 1 comprises the steps of:
receiving a denial notification,
if an automated data transfer process is deselected by the desired transceiver;
prompting the desired transceiver to accept the computing device in order to receive the user information, the pre-existing medical conditions, and the adverse reaction information through the wireless network; and
receiving the user information, the pre-existing medical conditions, and the adverse reaction information,
if the computing device is accepted by the desired transceiver.

7. The automated and timely method of notifying the possibility of an adverse reaction at point of service as claimed in claim 1 comprises the steps of:
receiving a denial notification,
if an automated data transfer process is deselected by the desired transceiver;
transferring the electronic identification number to an external database, wherein the external database is communicatively coupled with the computing device; and
receiving the user information, the pre-existing medical conditions, and the adverse reaction information for the electronic identification number, wherein the electronic identification number, the user information, the pre-existing medical conditions, and the adverse reaction information are stored within the external database.

8. The automated and timely method of notifying the possibility of an adverse reaction at point of service as claimed in claim 1 comprises the steps of:
providing a plurality of transceivers as the at least one data-transceiver;
temporarily assigning the electronic identification number for each of the plurality of transceivers into a list of service seekers;
descendingly organizing the list of service seekers with a signal strength of each of the plurality of transceivers for a pre-defined time period;
selecting the desired transceiver from the list of service seekers, wherein the desired transceiver is the closest transceiver to the computing device; and
prompting the desired transceiver to transmit the user information, the pre-existing medical conditions, and adverse reaction information.
